(19) United States
(12) Patent Application Publication
(10) Pub. No.: US 2004/0226802 A1
(43) Pub. Date: Nov. 18, 2004

(54) Money changer for coin operated vending machines

(76) Inventor: Thorsten Schneider, Apensen (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/844,189

(22) Filed: May 12, 2004

(30) Foreign Application Priority Data
May 17, 2003 (DE) 103 22 384.3

(51) Int. Cl. G07D 9/00; G07D 5/02

(52) U.S. Cl. 194/335; 453/16

(57) ABSTRACT

Money changer for coin-operated vending machines with a tube cassette comprising a plurality of coin tubes and which is arranged with a coin validator and a sorting device and comprises a pay out device for paying out coins from the coin tubes, a full- and empty sensor for each coin tube and an electronic control device for the coin validator and the money changer, such that the coin types to be accepted assigned to test channels in the coin validator, the value of the coin types to be accepted and the assignment of the coin tubes to the test channels are stored in a non-volatile memory, the control device further comprising tube counters which count the coins sorted in the coin tubes and paid out from the coin tubes, each coin tube being assigned at least one further filling level sensor between its ends and the reading of the tube counter being corrected according to the filling level determined by the further filling level sensor.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Money changers in a vending machine are conventionally arranged with a coin validator and a sorting device. They generally comprise tubes for storing coins, in which the coins are stored after passing through the sorting device. A pay out device pays out the coins from the tubes according to the calculated change.

For fault-free operation of the money changer it is known to assign a full- and empty sensor to each tube. As soon as the coin column covers one of the sensors, a corresponding signal is given. The empty sensor is conventionally arranged at a certain distance above the base of the coin tube. It primarily has the function of signalling the imminent emptying of the coin tube. In the electronic control device, conventionally a microprocessor, each coin tube is also assigned a tube counter which counts the coins inserted into the coin tube and paid out therefrom. For various reasons it can arise that the counter reading does not correspond to the actual filling level in the coin tube. Amongst other things this is because no correction took place during the removal or filling up of coins. When the coin column however reaches one of the two sensors, the filling level in the tube counter can naturally be corrected.

When coins are removed from the vending machine, in particular from the cash box, but also from the tubes, it must be ensured that sufficient coins are available in the coin tubes, so that a payout of change can take place. On the other hand the operator of the vending machine endeavours to leave only as many coins in the apparatus as absolutely necessary. It is therefore known to assign a so called float level to each coin tube, according to the value and number of coins, i.e. to ensure that coins are filled up or left only as far as the float level. Such a float level is also stored in a non volatile memory of the electronic control device. When emptying or filling up a coin tube the user can therefore recognise whether the float level has been reached. A precise indicator is however only possible when the tube counter is at the correct reading. If it does not correspond with the filling level the user cannot accurately adjust the number of coins to the float level.

The tube cassette is generally hingeably arranged in the vending machine, whereby a user can also fill up the tubes by hand. In this case it is not possible to count the inserted coins with the tube counter. Inserting coins directly into the tubes proves to be considerably quicker than via the coin validator, so this means is frequently used. With conventional money changers the tubes have to be manually filled as far as the full sensor, thus the coin counter is moved to the correct reading. If it is not filled up as far as the full sensor, only the empty sensor is covered. As a result it can be assumed that at least such a number of coins are in the tube as is necessary to cover the empty sensor, for example 10 coins. In reality, the tube can however be filled with many more coins. A precise adjustment of the tube contents can only take place when during normal operation the full sensor is covered by the insertion of coins or falls below the empty sensor by paying out the tube contents. This can possibly last a long time or not occur at all.

The object of the invention is to improve a money changer of the prior art such that a quicker filling level correction is achieved.

### BRIEF SUMMARY OF THE INVENTION

With the money changer according to the invention at least one further filling level sensor is assigned to the coin tubes between their ends. With the aid of the signal from this sensor the filling level correction can be finely graduated. Two further filling level sensors are preferably assigned to the coin tubes at a distance from one another. The additional filling level sensors are for example located at approximately 50% and 75% of the tube capacity. If a tube is manually filled to such an extent that the coin stack lies between the 50% and the 75% sensors, it can be assumed therefrom that at least sufficient coins are stored in the coin tube for the 50% sensor to be covered but not the 75% sensor. As a result a more precise monitoring of the filling level results than in the prior art. If coins are inserted during the normal operating mode an adjustment of the filling level is carried out even when the 75% sensor has been reached. If coins are paid out of the tubes, a more precise adjustment of the filling level is carried out even when it falls below the 50% sensor.

With the aid of the invention it is furthermore easier to reach the float level when filling or emptying the coin tubes. This normally occurs by filling via the coin validator or by emptying via the pay out device. By the relatively rapid correction via the additional sensors the precise float level is thus rapidly reached.

To carry out a correction of the tube counter using the filling level sensor, the respective reference counter readings for each sensor and for each type of coin have to be stored in the electronic control device. If these counter readings are stored for all possible coin types a high memory capacity is required. With for example 16 coin types to be accepted and 4 filling level sensors for 4 coin tubes, 64 counter readings have to be stored in a non-volatile memory. Depending on which type of coin is sorted in the tubes available, the respective tube counter is used.

Thus an embodiment of the invention provides that the thickness of the coins to be accepted is stored in the non-volatile memory of the electronic control device and the control device calculates the number of coins in the relevant coin tube from the thickness of the coins in a coin tube and from the signal of the third or fourth sensor. The thickness of each type of coin is thus stored in the volatile memory. Depending on which type of coin is sorted in the available coin tube, the control device calculates the respective counter readings. This is possible as the distance from the tube base to the respective sensor is known and does not change. This calculated reference counter reading can then be used or stored in a volatile or non volatile memory to save multiple calculations.

With 16 possible coin types and four sensors per coin tube only 16 coin thicknesses have to be stored in non-volatile memory. The resulting reference counter reading is therefore calculated as follows:

The distance of the sensor from the tube base divided by the coin thickness gives the reference counter reading.

When the money changer is configured the following input is required in the electronic control device and stored in non-volatile memory:

1. Assignment of the coins to the channels 1 to 16 in the coin validator

2. Coin value

3. Coin thickness

4. Assignment of the coins to the position in the tube cassette

When the tube set is changed only the assignment of the coin tubes to the coin channels changes and is stored in non-volatile memory.

Using the new data the control device can generate all other data and calculate the counter readings.

The invention is hereinafter described in more detail with reference to an embodiment.

The only drawing shows two coin tubes which are respectively filled with a coin stack of the same height.

In the drawing two coin tubes are shown, one of which is conventionally constructed and the other according to the invention. Conventionally the money changer comprises 3 or 4 such coin tubes. When Euro coins are accepted and changed, the tubes are generally designed for accepting 5, 10, 20 and 50 Cent coins. The coin tubes are generally held together in a cassette which is removably arranged in the coin-operated vending machine or is at least hingeable. The above described objects are not shown and generally known.

The left coin tube shows a coin tube according to the prior art with a full sensor and an empty sensor. These are indicated by FULL and EMPTY. In this coin tube there is a coin stack of 60 coins. The empty sensor is covered when there are 10 coins in the coin tube. A coin tube counter also not shown and described in more detail counts the coins sorted in the coin tube and paid out, the level thereof not always corresponding to the actual filling level in the coin tube, in particular when manual filling has taken place directly and not via the coin validator. Manual filling is assumed in the embodiment shown. Thus when inserting coins an adjustment of the tube counter can only take place after forty coins or when paying out when 51 coins are dispensed. The correct adjustment represents a considerable cost in servicing. In normal operation an adjustment possibly does not occur at all if the stack neither reaches the full sensor nor falls below the empty sensor.

In the right coin tube in the drawing, in addition to the full and empty sensors, two additional filling level sensors are indicated in the drawing which are arranged at 50% and 75% of the entire filling height (positions 2 and 3, where on the other hand position 1 represents the empty state and position 4 the full state). It is to be recognised that when inserting coins an adjustment of the filling level is carried out relative to the coin tube counter after only 15 coins and when paying out after only 11 coins.

A table is shown hereinafter, in which examples for the distances of the tube sensors and the filling amounts are given relative to individual coin types.

At positions 1 to 4 the respective distance of the sensor from the tube base is given. Moreover, in addition to the coin type the thickness thereof is shown (in mm). In the columns T1 to T4 the number of coins is given for the respective positions.

| | | mm |
|---|---|---|
| Position 4 | 146.75 | Rounded up/down |

| Thickness | e.g. [symbol] Cent | T1 | T2 | T3 | T4 |
|---|---|---|---|---|---|
| 5 Cent | 1.67 | 87 | 87 | 87 | 87 |
| 10 Cent | 1.93 | 76 | 76 | 76 | 76 |
| 20 Cent | 2.14 | 68 | 68 | 68 | 68 |
| 50 Cent | 2.38 | 61 | 61 | 61 | 61 |
| Coin. . . | | | | | |
| Coin 16 | | | | | |

| | | |
|---|---|---|
| Position 3 | 110.5 | mm |

| Thickness | e.g. [symbol] Cent | T1 | T2 | T3 | T4 |
|---|---|---|---|---|---|
| 5 Cent | 1.67 | 66 | 66 | 66 | 66 |
| 10 Cent | 1.93 | 57 | 57 | 57 | 57 |
| 20 Cent | 2.14 | 51 | 51 | 51 | 51 |
| 50 Cent | 2.38 | 46 | 46 | 46 | 46 |
| Coin. . . | | | | | |
| Coin 16 | | | | | |

| | | |
|---|---|---|
| Position 2 | 73.5 mm | mm |

| Thickness | e.g. [symbol] Cent | T1 | T2 | T3 | T4 |
|---|---|---|---|---|---|
| 5 Cent | 1.67 | 44 | 44 | 44 | 44 |
| 10 Cent | 1.93 | 38 | 38 | 38 | 38 |
| 20 Cent | 2.14 | 34 | 34 | 34 | 34 |
| 50 Cent | 2.38 | 30 | 30 | 30 | 30 |
| Coin. . . | | | | | |
| Coin 16 | | | | | |

| | | |
|---|---|---|
| Position 1 | 19.1 mm | mm |

| Thickness | e.g. [symbol] Cent | T1 | T2 | T3 | T4 |
|---|---|---|---|---|---|
| 5 Cent | 1.67 | 11 | 11 | 11 | 11 |
| 10 Cent | 1.93 | 9 | 9 | 9 | 9 |
| 20 Cent | 2.14 | 8 | 8 | 8 | 8 |
| 50 Cent | 2.38 | 8 | 8 | 8 | 8 |
| Coin. . . | | | | | |
| Coin 16 | | | | | |

| | | |
|---|---|---|
| Position 1 | 19.1 | mm |

| Thickness | e.g. US Cent | T1 | T2 | T3 | T4 |
|---|---|---|---|---|---|
| 5 Cent | 1.98 | 9 | 9 | 9 | 9 |
| 10 Cent | 1.35 | 14 | 14 | 14 | 14 |
| 25 Cent | 1.70 | 11 | 11 | 11 | 11 |
| 1$ | 2.00 | 9 | 9 | 9 | 9 |
| Coin. . . | | | | | |
| Coin 16 | | | | | |

In a further embodiment of the invention the calculation of the reference counter reading for position 1 to 4 can be established from one already known/given reference counter reading of positions 1 to 4, as the distances of the positions above the tube bases are always closely related to one another and are known.

For each of the maximum 16 coins to be accepted a tube counter reading, in the following example the 100% value, is stored in non-volatile memory.

The reference counter readings for the individual positions are therefore calculated from the values given in the following table.

Pre-setting: 10 Cent coin Reference counter reading

Tube full/Position 4=76 coins

| | Height | | Tube | Rounded |
|---|---|---|---|---|
| | above tube | | capacity | up/down counter |
| | base in mm | Function | in % | reading |
| Position 4 | 146.75 | Tube full | 100 | 73 |
| Position 3 | 110.5 | | 75 | 57 |
| Position 2 | 73.5 | | 50 | 38 |
| Position 1 | 19.1 | Tube empty | 13 | 9 |

[image]

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What we claim is:

1. Money changer for coin-operated vending machines with a tube cassette comprising a plurality of coin tubes which is arranged with a coin validator and a sorting device and comprises a pay out device for paying out coins from the coin tubes, a full- and empty sensor for each coin tube and an electronic control device for the coin validator and the money changer in such a manner that the coin types to be accepted assigned to test channels in the coin validator, the value of the coin types to be accepted and the assignment of the coin tubes to the test channels are stored in a non-volatile memory, the control device further comprising tube counters which count the coins sorted in the coin tubes and paid out from the coin tubes, characterised in that each coin tube is assigned at least one further filling level sensor between its ends and the reading of the tube counter is corrected according to the filling level determined by the further filling level sensor.

2. Money changer according to claim 1, characterised in that two tube sensors are arranged between the ends of the coin tubes at a distance from one another.

3. Money changer according to claim 1, characterised in that the thickness of the coins to be accepted is stored in the non-volatile memory of the electronic control device and the control device calculates the number of coins in the relevant coin tube from the thickness of the coins in a coin tube and the signal from the third or fourth sensor.

4. Money changer according to claim 1, characterised in that a reference counter reading is determined for all positions assigned to the filling level sensors from the known filling level of a position.
